(19) United States
(12) Patent Application Publication
(10) Pub. No.: US 2014/0282792 A1
(43) Pub. Date: Sep. 18, 2014

(54) VIDEO STREAMING WITH BUFFER OCCUPANCY PREDICTION BASED QUALITY ADAPTATION

(71) Applicant: Cygnus Broadband, Inc., San Diego, CA (US)

(72) Inventors: Yiliang Bao, San Diego, CA (US); David Gell, San Diego, CA (US)

(73) Assignee: Cygnus Broadband, Inc., San Diego, CA (US)

(21) Appl. No.: 14/040,199

(22) Filed: Sep. 27, 2013

Related U.S. Application Data
(60) Provisional application No. 61/798,384, filed on Mar. 15, 2013.

(51) Int. Cl. H04N 21/44; H04N 21/433

(52) U.S. Cl. CPC H04N 21/44004; H04N 21/4331
USPC 725/116

(57) ABSTRACT

Video streaming with buffer occupancy prediction based quality adaptation is provided by obtaining a plurality of segment lengths each of which corresponds to each one of a set of video segments, each video segment being associated with one of multiple candidate video representations, predicting a segment transfer time for each obtained segment length, and selecting one of the multiple candidate video representations, the selection being based at least in part on a buffer occupancy variation corresponding to each predicted segment transfer time.

### CROSS-REFERENCE TO RELATED APPLICATIONS

This application claims the benefit of U.S. provisional application No. 61/798,384, filed Mar. 15, 2013, which is fully incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention generally relates to the field of video streaming in a communication system, such as a wireless communication network.

In a video streaming system, such as hypertext transfer protocol (HTTP) video streaming, a tension exists between the limited network throughput capacity and the resolution and quality of the received video content that can impact the quality of experience for the user of a terminal device, such as a mobile phone, receiving the video content. A quality adaptation control algorithm may be used in the terminal device to select between different “representations” of the video content based on video buffer occupancy (BO). The different representations have different bit rates and different video quality. Such an algorithm (referred to as BO feedback) attempts to obtain the appropriate video representation to prevent buffer underflow, which can result in glitches and pauses in video playback, and to prevent buffer overflow, which means that network throughput capacity is being unnecessarily wasted by the terminal device.

Performance issues exist with a quality adaptation control algorithm based on simple BO feedback. First, the video streaming client in the terminal device can switch among different video representations too frequently, which has an adverse effect on video quality for the user. Another issue is that the buffer occupancy can still reach its upper limit occasionally. This latter problem can be alleviated by increasing a feedback scaling factor, but a higher scaling factor can push the average BO too low and make it more susceptible to buffer underflow. In addition, the switching among different video representations can become more frequent, because the change in BO will have larger effect on the estimated throughput used in the quality adaptation control algorithm based on BO.

### SUMMARY

In one aspect, a terminal node is provided. The terminal node includes a transceiver module configured to communicate with an access node; and a processor coupled to the transceiver and configured to: obtain a plurality of segment lengths each of which corresponds to each one of a set of video segments, each video segment being associated with one of multiple candidate video representations; predict a segment transfer time for each obtained segment length; and select one of the multiple candidate video representations, the selection being based at least in part on a buffer occupancy variation corresponding to each predicted segment transfer time.

In one aspect, a video streaming client device is provided for receiving video streaming data of a video presentation that is available in a plurality of candidate video representations, each of the candidate video representations including a plurality of video segments. The video streaming client device comprises a memory configured to store data and processing instructions, and a processor configured to retrieve and execute the processing instructions stored in the memory to cause the processor to perform the steps of obtaining a plurality of segment lengths each of which corresponds to one of the plurality of video segments from each one of the candidate video representations, predicting a segment transfer time for each obtained segment length, and selecting one of the candidate video representations, the selection being based at least in part on a buffer occupancy variation corresponding to each predicted segment transfer time.

In one aspect, a method for receiving a video streaming presentation having multiple candidate video representations is provided. The method includes obtaining a plurality of segment lengths each of which corresponds to each one of a set of video segments, each video segment being associated with one of the multiple candidate video representations, predicting a segment transfer time for each obtained segment length, and selecting one of the multiple candidate video representations, the selection being based at least in part on a buffer occupancy variation corresponding to each predicted segment transfer time.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a communication network in which embodiments disclosed herein can be implemented in accordance with aspects of the invention;

FIG. 2 is a block diagram of an access node in accordance with aspects of the invention;

FIG. 3 is a block diagram of a terminal node in accordance with aspects of the invention;

FIG. 4 is a block diagram of a communication system supporting video streaming in accordance with aspects of the invention;

FIG. 5 is a block diagram of a video streaming environment with adaptive bit rate in accordance with aspects of the invention;

FIG. 6 is a block diagram of a protocol stack to support video streaming in accordance with aspects of the invention;

FIG. 7 is a block diagram illustrating aspects of a video streaming client module with buffer occupancy feedback in accordance with aspects of the invention;

FIG. 8 is a block diagram illustrating aspects of a video streaming client module with buffer occupancy prediction in accordance with aspects of the invention;

FIG. 9 is a flowchart of a process for video streaming with buffer occupancy prediction in accordance with aspects of the invention;

FIG. 10 is a flowchart of a process for obtainment of segment lengths for video streaming with buffer occupancy prediction in accordance with aspects of the invention;

FIG. 11 is a block diagram of a segment transfer time prediction module in accordance with aspects of the invention;

FIG. 12 is a flowchart of a process for segment transfer time prediction in accordance with aspects of the invention;

FIG. 13 is a block diagram of a segment access representation selection module in accordance with aspects of the invention;

FIG. 14 is a flowchart of process for segment access representation selection in accordance with aspects of the invention;

FIG. 15 is a graph of video bit rate versus presentation time for one representation of an example video;

FIG. 16 is a graph of video buffer occupancy versus time for one representation of the example video of FIG. 15;

FIG. 17 is another graph of video buffer occupancy versus time during a video streaming session for an example video with multiple representations;

FIG. 18 is a graph that depicts switching among different representations during the video streaming session for the example video of FIG. 17 with multiple representations;

FIG. 19 is a graph of transfer time versus segment length for an example communication system;

FIG. 20 is a graph of TCP throughput versus segment length for the example communication system of FIG. 19;

FIG. 21 is a graph of transfer time versus segment length for another example communication system;

FIG. 22 is a graph of TCP throughput versus segment length for the example communication system of FIG. 21;

FIG. 23 is a graph showing a trace of TCP packets transferred versus time for an example video segment;

FIG. 24 is a graph of transfer time versus sequence number for an example video; and

FIG. 25 is a graph of transfer time versus sequence number for a portion of the example video of FIG. 24.

### DETAILED DESCRIPTION

Descriptions of video streaming with buffer-occupancy prediction, which can improve a user's quality of experience (QoE), are provided. The features disclosed herein can be applied to various communication systems, including wireline and wireless technologies. Such communication systems may be capacity-limited. For example, the features disclosed herein can be used with Cellular 2G, 3G, 4G (including Long Term Evolution (LTE), LTE Advanced, and WiMAX), cellular backhaul, Wi-Fi, Ultra Mobile Broadband (UMB), cable modem, and other point-to-point or point-to-multipoint wireline or wireless technologies. For concise exposition, various aspects are described using terminology and organization of particular technologies and standards. However, the features described herein are broadly applicable to other technologies and standards.

FIG. 1 is a block diagram of a communication network in which features disclosed herein can be implemented in accordance with aspects of the invention. A macro base station 110 is connected to a core network 102 through a backhaul connection 170. In an embodiment, the backhaul connection 170 is a bidirectional link or two unidirectional links. The direction from the core network 102 to the macro base station 110 is referred to as the downstream or downlink (DL) direction. The direction from the macro base station 110 to the core network 102 is referred to as the upstream or uplink (UL) direction. Subscriber stations 150(1) and 150(4) can connect to the core network 102 through the macro base station 110. Wireless links 190 between subscriber stations 150(1) and 150(4) and the macro base station 110 are bidirectional point-to-multipoint links, in an embodiment. The direction of the wireless links 190 from the macro base station 110 to the subscriber stations 150(1) and 150(4) is referred to as the downlink or downstream direction. The direction of the wireless links 190 from the subscriber stations 150(1) and 150(4) to the macro base station 110 is referred to as the uplink or upstream direction. Subscriber stations are sometimes referred to as user equipment (UE), users, user devices, handsets, terminal nodes, or user terminals and are often mobile devices such as smart phones or tablets. The subscriber stations 150(1) and 150(4) access content over the wireless links 190 using base stations, such as the macro base station 110, as a bridge. That is to say, the base stations generally pass user application data and any user application control messages between the subscriber stations 150(1) and 150(4) and the core network 102 without the base station being a destination for the data and control messages or a source of the data and control messages.

In the network configuration illustrated in FIG. 1, an office building 120(1) causes a coverage shadow 104. A pico station 130 can provide coverage to subscriber stations 150(2) and 150(5) in the coverage shadow 104. The pico station 130 is connected to the core network 102 via a backhaul connection 170. The subscriber stations 150(2) and 150(5) may be connected to the pico station 130 via links that are similar to or the same as the wireless links 190 between subscriber stations 150(1) and 150(4) and the macro base station 110.

In office building 120(2), an enterprise femtocell 140 provides in-building coverage to subscriber stations 150(3) and 150(6). The enterprise femtocell 140 can connect to the core network 102 via an internet service provider network 101 by utilizing a broadband connection 160 provided by an enterprise gateway 103.

FIG. 2 is a functional block diagram of an access node 275 in accordance with aspects of the invention. In various embodiments, the access node 275 may be a mobile WiMAX base station, a global system for mobile (GSM) wireless base transceiver station (BTS), a Universal Mobile Telecommunications System (UMTS) NodeB, an LTE evolved Node B (eNB or eNodeB), a cable modem head end, or other wireline or wireless access node of various form factors. For example, the macro base station 110, the pico station 130, or the enterprise femtocell 140 of FIG. 1 may be provided, for example, by the access node 275 of FIG. 2. The access node 275 includes a processor module 281. The processor module 281 is coupled to a transmitter-receiver (transceiver) module 279, a backhaul interface module 285, and a storage module 283.

The transmitter-receiver module 279 is configured to transmit and receive communications with other devices. In many implementations, the communications are transmitted and received wirelessly. In such implementations, the access node 275 generally includes one or more antennae for transmission and reception of radio signals. In other implementations, the communications are transmitted and received over physical connections such as wires or optical cables. The communications of the transmitter-receiver module 279 may be with terminal nodes.

The backhaul interface module 285 provides communication between the access node 275 and a core network. The communication may be over a backhaul connection, for example, the backhaul connection 170 of FIG. 1. Communications received via the transmitter-receiver module 279 may be transmitted, after processing, on the backhaul connection. Similarly, communication received from the backhaul connection may be transmitted by the transmitter-receiver module 279. Although the access node 275 of FIG. 2 is shown with a single backhaul interface module 285, other embodiments of the access node 275 may include multiple backhaul interface modules. Similarly, the access node 275 may include multiple transmitter-receiver modules. The multiple backhaul interface modules and transmitter-receiver modules may operate according to different protocols.

The processor module 281 can process communications being received and transmitted by the access node 275. The storage module 283 stores data for use by the processor module 281. The storage module 283 may also be used to store computer readable instructions for execution by the processor module 281. The computer readable instructions can be used by the access node 275 for accomplishing the various functions of the access node 275. In an embodiment, the storage module 283 or parts of the storage module 283 may be considered a non-transitory machine readable medium. For concise explanation, the access node 275 or aspects of it are described as having certain functionality. It will be appreciated that in some aspects, this functionality is accomplished by the processor module 281 in conjunction with the storage module 283, transmitter-receiver module 279, and backhaul interface module 285. Furthermore, in addition to executing instructions, the processor module 281 may include specific purpose hardware to accomplish some functions.

FIG. 3 is a functional block diagram of a terminal node in accordance with aspects of the invention. The terminal node 300 can be used for viewing streaming video. In various example embodiments, the terminal node 300 may be a mobile device, for example, a smartphone or tablet or notebook computer. The terminal node 300 includes a processor module 320. The processor module 320 is communicatively coupled to a transmitter-receiver module (transceiver) 310, a user interface module 340, a storage module 330, and a camera module 350. The processor module 320 may be a single processor, multiple processors, or a combination of one or more processors and additional logic such as application-specific integrated circuits (ASIC) or field programmable gate arrays (FPGA).

The transmitter-receiver module 310 is configured to transmit and receive communications with other devices. For example, the transmitter-receiver module 310 may communicate with a cellular or broadband base station such as an LTE evolved node B (eNodeB) or WiFi access point (AP). In example embodiments where the communications are wireless, the terminal node 300 generally includes one or more antennae for transmission and reception of radio signals. In other example embodiments, the communications may be transmitted and received over physical connections such as wires or optical cables and the transmitter/receiver module 310 may be an Ethernet adapter or cable modem. Although the terminal node 300 of FIG. 3 is shown with a single transmitter-receiver module 310, other example embodiments of the terminal node 300 may include multiple transmitter-receiver modules. The multiple transmitter-receiver modules may operate according to different protocols.

The terminal node 300, in some example embodiments, provides data to and receives data from a person (user). Accordingly, the terminal node 300 includes a user interface module 340. The user interface module 340 includes modules for communicating with a person. The user interface module 340, in an exemplary embodiment, may include a display module 345 for providing visual information to the user, including displaying video content. In some example embodiments, the display module 345 may include a touch screen which may be used in place of or in combination with a keypad connected to the user interface module 340. The touch screen may allow graphical selection of inputs in addition to alphanumeric inputs.

In an alternative example embodiment, the user interface module 340 may include a computer interface, for example, a universal serial bus (USB) interface, to interface the terminal node 300 to a computer. For example, a wireless modem, such as a dongle, may be connected, by a wired connection or a wireless connection, to a notebook computer via the user interface module 340. Such a combination may be considered to be a terminal node 300. The user interface module 340 may have other configurations and include hardware and functionality such as speakers, microphones, vibrators, and lights.

The processor module 320 can process communications received and transmitted by the terminal node 300. The processor module 320 can also process inputs from and outputs to the user interface module 340 and the camera module 350. The storage module 330 may store data for use by the processor module 320, including images or metrics derived from images. The storage module 330 may also be used to store computer readable instructions for execution by the processor module 320. The computer readable instructions can be used by the terminal node 300 for accomplishing the various functions of the terminal node 300. Storage module 330 can also store received content, such as video content that is received via transmitter/receiver module 310.

The storage module 330 may also be used to store photos and videos, such as those taken by the camera module 350. In an example embodiment, the storage module 330 or parts of the storage module 330 may be considered a non-transitory machine readable medium. In an example embodiment, storage module 330 may include a subscriber identity module (SIM) or machine identity module (MIM).

For concise explanation, the terminal node 300 or example embodiments of it are described as having certain functionality. It will be appreciated that in some example embodiments, this functionality is accomplished by the processor module 320 in conjunction with the storage module 330, the transmitter-receiver module 310, the camera module 350, and the user interface module 340. Furthermore, in addition to executing instructions, the processor module 320 may include specific purpose hardware to accomplish some functions.

The camera module 350 can capture video and still photos as is common with a digital camera. The camera module 350 can display the video and still photos on the display module 345. The user interface module 340 may include a button which can be pushed to cause the camera module 350 to take a photo. Alternatively, if the display module 345 comprises a touch screen, the button may be a touch sensitive area of the touch screen of the display module 345.

The camera module 350 may pass video or photos to the processor module 320 for forwarding to the user interface module 340 and display on the display module 345. Alternatively, the camera module 350 may pass video or photos directly to the user interface module 340 for display on the display module 345.

FIG. 4 is a block diagram of a communication system supporting video streaming in accordance with aspects of the invention. A terminal node 455 communicates with a video server 410 to facilitate providing video to a video client at the terminal node 455. Various elements of the communication system may be the same or similar to like named elements described above. The terminal node 455 may be, for example, the terminal node described above with respect to FIG. 3.

The terminal node 455 in the communication system shown in FIG. 4 communicates with an access node 475 over a channel 490. The access node 475 is connected to a gateway node 495. The gateway node 495 provides access to the Internet via connectivity to a router node 493. The router node 493 provides access to the video server 410. Video passes from the Internet 401 to the mobile network 402 via the gateway node 495 which transfers the video to the access node 475.

The video server 410 stores video content 412. The video server 410 may provide the video content 412 to a video encoder 411. The video encoder 411 encodes the video for use by the video client at the terminal node 455. The video encoder 411 may encode the video content 412 as it is streamed (e.g., for live streaming events) or may encode the video in advance for storage and later streaming. The video encoder 411 may encode the video in different formats, profiles, or quality levels, for example, formats with different bit rates. The different video formats may be referred to as video representations. The format, profile, or quality level streamed can be switched while streaming. The different formats, profiles, or quality levels can be stored in advance or generated while streaming. The video server 410 provides video clients with access to the encoded video.

The access node 475 controls the transmission of data to and from the terminal node 455 via the channel 490. Accordingly, the access node 475 may include an admission control module, a scheduler module, and a transmission-reception module. The access node 475 may also include a packet inspection module. Alternatively or additionally, the gateway node 495 may include a packet inspection module.

The access node 475 monitors congestion on the channel 490. The congestion may be with respect to particular terminal nodes. The access node 475 may, for example, detect that video transmissions to the terminal node 455 are of a type that uses an adaptive video client that monitors its packet reception rates and decoder buffer depths and will request a different video rate from the video server 410 when the terminal node 455 deems that such action will preserve or improve user quality of experience.

FIG. 5 is a block diagram of a video streaming environment with adaptive bit rate in accordance with aspects of the invention. The video streaming environment may be performed in the communication systems of FIG. 4. The video streaming environment of FIG. 5 includes a video encoder and bitstream segmenter 511, a video storage 520, a video server 510, and a video client 555. To provide a specific example, the video streaming environment shown in FIG. 5 will be described for HTTP video streaming; however, video streaming environments according to other standards and protocols can be used.

HTTP video streaming often uses a manifest file which provides information of a presentation to the video client 555 for use in controlling the playback process. A video presentation may be referred to as simply a presentation. The manifest file may have various formats. A manifest file using Media Presentation Description (MPD) defined in MPEG/3GPP DASH is described below.

The video encoder and bitstream segmenter 511 generates multiple video representations for the same video presentation. The video encoder and bitstream segmenter 511 can store the video representations and a corresponding manifest/playlist file 525 in the video storage 520. A video representation may be referred to as simply a representation. The video representations have different bit rates. For example, a first video representation 530 has a low bit rate, a second video representation 540 has a medium bit rate, and a third video representation 550 has a high bit rate.

The video encoder and bitstream segmenter 511 also divides the video representation into video segments. A video segment may be referred to as simply a segment. Each video representation includes multiple video segments that are independently decodable. The first video representation 530 includes a first video segment 531, a second video segment 532, and a third video segment 533. The second video representation 540 includes a first video segment 541, a second video segment 542, and a third video segment 543. The third video representation 550 includes a first video segment 551, a second video segment 552, and a third video segment 553. The video segments are aligned in decoding time across the different video representations. Thus, a continuous video can be displayed from video segments selected from any combination of the video representations. The illustrated media has three levels of data hierarchy—presentation, representation, and segment.

Information about the video representations, such as average bit rate (e.g., over the entire presentation), and URLs of the video segments inside each representation may be summarized in a manifest file. The video segments and manifest file can be stored in the video server 510, which may be a single server or may be distributed across multiple servers or storage systems.

The video client 555 can retrieve data from the video server 510 by sending requests 564. The video client 555 may first retrieve the manifest file 563, which is a copy of the manifest file 525 on the server. The video client 555 can then play the video by fetching the video segments forming a video stream 561. The video segments fetched may be selected based on network conditions. If the network bandwidth is not sufficient, the video client 555 may fetch following video segments from a video representation of lower quality. Once the network bandwidth increases at another time, the video client 555 may fetch segments from a video representation of higher quality. For example, the video client 555 may select the first video segment 541 from the second video representation 540, the second video segment 552 from the third video representation 550, and the third video segment 533 from the first video representation 530.

Since the network conditions between the video server 510 and the video client 555 may vary over time, the video client 555 may select video segments from more than one video representation. Additionally, since the network conditions may vary differently for different video clients, each client's video stream may be made up of a different set of video representations for video streaming sessions of the same video presentation.

The duration of a video segment is usually a few seconds in playback time. Using video segments of longer duration can make the compression and transport more efficient, but it will incur longer latency in switching across representations. The size of a video segment in bytes depends on factors, such as the segment duration, video content, and compression settings. The segment length or segment size normally refers to the number of bytes in a segment, while the segment duration refers to how long in time the segment can be played.

FIG. 6 is a block diagram of a protocol stack 600 to support video streaming in accordance with aspects of the invention. The protocol stack 600 of FIG. 6 is for HTTP video streaming. There are currently many proprietary HTTP streaming technologies, such as Apple HTTP Live Streaming, Microsoft Smooth Streaming, and Adobe Dynamic Streaming. The basic concepts are similar, but they differ in the format of the manifest file and the video container file which encapsulates video data into segments. These differences make them incompatible with each other. The protocol stack 600 shown in FIG. 6 includes an Internet protocol (IP) layer 609, a transmission control protocol (TCP) layer 607, an HTTP layer 605, a container file 604, a manifest/playlist layer 603, and a media (audio/video) layer 601. The protocol stack 600 may be implemented, for example, by the processor module 320 of the terminal node of FIG. 3.

Apple's HTTP streaming protocol is HTTP Live Streaming (HLS). HLS uses MPEG-2 transport stream (TS) to encapsulate video data. Instead of using a comprehensive manifest file, HLS uses a simple playlist file for retrieving the basic information about video representations and the video segments in the video representations.

Microsoft's HTTP streaming protocol is called Microsoft Smooth Streaming. Microsoft Smooth Streaming uses a fragmented video file format derived from ISO base media file format (ISOBMFF) and its proprietary XML-based manifest file format. Microsoft Smooth Streaming uses PIFF (Protected Interoperable File Format) as the video container format. Microsoft Smooth Streaming may also use other container file formats such as those based on Advanced Systems Format (ASF).

Adobe's HTTP streaming protocol is called HTTP Dynamic Streaming. It uses a fragmented video file format based on ISOBMFF, so it is quite similar to Microsoft HTTP Smooth Streaming, if the latter uses an ISOBMFF-based video file format as well. However, the two HTTP streaming protocols define extensions to ISOBMFF differently, and the manifest file formats are also different.

Realizing the market potential of HTTP streaming, MPEG/3GPP standardization groups specified DASH (Dynamic Adaptive Streaming over HTTP) as an open standard to solve the issue of having multiple incompatible, proprietary HTTP streaming technologies in the market.

DASH uses an XML-based manifest file called MPD (Media Presentation Description) file. While 3GPP DASH adopts a video container file format based solely on the ISO base media file format (ISOBMFF), MPEG DASH supports an additional video container file format based on MPEG-2 transport stream format in some profiles, such as full profile, MPEG-2 TS simple profile, and MPEG-2 TS main profile.

DASH defines multiple levels for the media data hierarchy. A presentation is made up of one or more periods. Each period has one or more adaptation sets. An adaptation set contains one or more representations of one or several media content components. Each representation usually has a different quality setting. For example, if the representation contains video, the video quality may be varied by having a different resolution, a different frame rate, a different bit rate, or a combination of these variations. A representation is made up of one or more segments. The duration of a segment in playback time is typically a few seconds. A segment may further be made up of sub-segments. The additional levels in the media data hierarchy add flexibility in supporting additional features, but the disclosed quality adaptation control algorithms are equally applicable to protocols with different hierarchies.

Table 1 lists an example MPD file for 3GPP/DASH On-Demand Service. For the first period, whose duration is 30 seconds, the URL of each segment is explicitly defined. For the second period, which starts after 30 seconds, segment URL is not specified individually. A video client should derive the segment URL using a template, “http://example.com/$RepresentationId$/$Number$0.3gp”, specified in the element <SegmentTemplate>. For example, the URL of segment number “4” in representation of id “1” is determined to be “http://example.com/1/4.3gp”. Using a template can reduce the size of an MPD file.

TABLE 1
Example MPD File for 3GPP/DASH On-Demand Service

```
<?xml version=“1.0”?>
<MPD
    profiles=“urn:3GPP:PSS:profile:DASH10”
    type=“static”
    minBufferTime=“PT10S”
    mediaPresentationDuration=“PT2H”
    availabilityStartTime=“2010-04-01T09:30:47Z”
    availabilityEndTime=“2010-04-07T09:30:47Z”
    xsi:schemaLocation=“urn:mpeg:DASH:schema:MPD:2011 3GPP-Rel10-MPD.xsd”
    xmlns:xsi=“http://www.w3.org/2001/XMLSchema-instance”
    xmlns=“urn:mpeg:DASH:schema:MPD:2011”>
    <ProgramInformation moreInformationURL=“http://www.example.com”>
        <Title>Example</Title>
    </ProgramInformation>
    <BaseURL>http://www.example.com</BaseURL>
    <Period start=“PT0S”>
        <AdaptationSet mimeType=“video/3gpp”>
            <ContentComponent contentType=“video”/>
            <ContentComponent contentType=“audio” lang=“en”/>
            <Representation codecs=“s263, samr” bandwidth=“256000” id=“256”>
                <BaseURL>“rep1”</BaseURL>
                <SegmentList duration=“1000” timescale=“100”>
                    <Initialization sourceURL=“seg-init.3gp”/>
                    <SegmentURL media=“seg-1.3gp”/>
                    <SegmentURL media=“seg-2.3gp”/>
                    <SegmentURL media=“seg-3.3gp”/>
                </SegmentList>
            </Representation>
            <Representation codecs=“mp4v.20.9, mp4a.E1” bandwidth=“128000”
id=“128”>
                <BaseURL>“rep2”</BaseURL>
                <SegmentList duration=“10”>
                    <Initialization sourceURL=“seg-init.3gp”/>
                    <SegmentURL media=“seg-1.3gp”/>
                    <SegmentURL media=“seg-2.3gp”/>
                    <SegmentURL media=“seg-3.3gp”/>
                </SegmentList>
            </Representation>
        </AdaptationSet>
    </Period>
    <Period start=“PT30S”>
        <SegmentTemplate
            duration=“10”
            initialization=“seg-init-$RepresentationId$.3gp”
            media=“http://example.com/$RepresentationId$/$Number$.3gp”/>
        <AdaptationSet mimeType=“video/3gpp” codecs=“mp4v.20.9, mp4a.E1”>
            <ContentComponent contentType=“video”/>
            <ContentComponent contentType=“audio” lang=“en”/>
            <Representation bandwidth=“256000” id=“1”/>
            <Representation bandwidth=“128000” id=“2”/>
        </AdaptationSet>
    </Period>
</MPD>
```

Table 2 lists an example of MPD file for MPEG/DASH MPEG-TS Simple Profile. In this profile, the video segment format is MPEG-TS (Transport Stream defined in ISO/IEC 13818-1). The segment URL is defined using a template specified in element <SegmentTemplate>.

TABLE 2
Example MPD File for MPEG/DASH MPEG-2 TS Simple Profile

```
<?xml version=“1.0”?>
<MPD
    xmlns:xsi=http://www.w3.org/2001/XMLSchema-instance
    xmlns=“urn:mpeg:DASH:schema:MPD:2011”
    xsi:schemaLocation=“urn:mpeg:DASH:schema:MPD:2011 DASH-MPD.xsd”
    type=“static”
    mediaPresentationDuration=“PT6158S”
    availabilityStartTime=“2011-05-10T06:16:42”
    minBufferTime=“PT1.4S”
    profiles=“urn:mpeg:dash:profile:mp2t-simple:2011”
    maxSegmentDuration=“PT4S”>
    <BaseURL>http://cdn1.example.com/</BaseURL>
    <BaseURL>http://cdn2.example.com/</BaseURL>
    <Period id=“42” duration=“PT6158S”>
        <AdaptationSet
            mimeType=“video/mp2t”
            codecs=“avc1.4D401F,mp4a”
            frameRate=“24000/1001”
            segmentAlignment=“true”
            subsegmentAlignment=“true”
            bitstreamSwitching=“true”
            startWithSAP=“2”
            subsegmentStartsWithSAP=“2”>
            <ContentComponent contentType=“video” id=“481”/>
            <ContentComponent contentType=“audio” id=“482” lang=“en”/>
            <ContentComponent contentType=“audio” id=“483” lang=“es”/>
            <BaseURL>SomeMovie_</BaseURL>
            <SegmentTemplate
                media=“$RepresentationID$_$Number%05$.ts”
                index=“$RepresentationID$.sidx”
                initialization=“$RepresentationID$-init.ts”
                bitstreamSwitching=“$RepresentationID$-bssw.ts”
                duration=“4”
                startNumber=“1”/>
            <Representation id=“720kbps” bandwidth=“792000” width=“640”
height=“368”/>
            <Representation id=“1130kbps” bandwidth=“1243000” width=“704”
height=“400”/>
            <Representation id=“1400kbps” bandwidth=“1540000” width=“960”
height=“544”/>
            <Representation id=“2100kbps” bandwidth=“2310000” width=“1120”
height=“640”/>
            <Representation id=“2700kbps” bandwidth=“2970000” width=“1280”
height=“720”/>
            <Representation id=“3400kbps” bandwidth=“3740000” width=“1280”
height=“720”/>
        </AdaptationSet>
    </Period>
</MPD>
```

FIG. 7 is a block diagram illustrating aspects of a video streaming client module with buffer occupancy feedback in accordance with aspects of the invention. The video streaming client module 700 may be implemented by, for example, the processor module 320 of the terminal node of FIG. 3. The streaming video client module 700 includes a top-level control module 701, a manifest access module 703, a video segment processor module 705, a video segment access module 707, an elementary stream buffer module 709, and an HTTP client module 713. The streaming video client module 700 interfaces with a TCP socket layer 730 and a video decoding and playback module 720.

The video streaming client module 700 handles all the protocol aspects of HTTP video streaming on the client side. The video streaming client module 700 requests the video content from the video server, typically using TCP connections, and delivers the video stream to the video decoding and playback module 720.

The top-level control module 701 maintains a state machine for the video streaming client module 700. The states include requesting a manifest file followed by requesting the video segments.

The manifest access module 703 issues a request for a manifest file through the HTTP client module 713. The manifest access module 703 also processes the manifest file received via the HTTP client module 713. The processing can include extracting information about a presentation, individual representations, and URLs of segments in the representations.

The video segment access module 707 issues requests for segments through the HTTP client module 713. The video segment access module 707 also receives the segments through HTTP client module 713. The video segment access module 707 delivers the received segments to the video segment processor module 705 for further processing. The video segment access module 707 makes decisions, using a quality control adaptation algorithm, on how to switch among different representations, for example, to optimize the quality of the video streaming session. Aside from the information from the manifest file, such as information about the presentation, the representations, and segments, the video segment access module 707 may also incorporate information such as buffer occupancy in the decisions about switching among different representations.

The video segment processor module 705 parses the video segments received by the video segment access module 707 and extracts the elementary streams, such as video streams or audio streams, and sends them to corresponding elementary buffers.

The elementary stream buffer module 709 stores the elementary streams extracted from the video segments, before they are consumed by the video decoding and playback module 720. A video session may have at least one video elementary stream, and one audio elementary stream. The elementary stream buffer module 790 is also able to report the buffer occupancy for each elementary stream. The buffer occupancy for an elementary stream is the amount of data in the elementary stream buffer that is available to play.

The HTTP client module 713 translates the requests for downloading the manifest and video segments into HTTP request messages and sends the messages through TCP connections that are managed by the HTTP client module 713. The HTTP client module 713 also receives the HTTP response messages from the server and delivers the content in the payloads of the HTTP response messages to either the manifest access module 703 or the video segment access module 707.

The video streaming client module 700 maintains the elementary stream buffer module 709 to accommodate variation in both video bit rate and network bandwidth. The elementary stream buffer module 709 has a buffer of a limited size. The buffer size may be specified in units of playable time (e.g., seconds) or bytes. The buffer size in units of time may be preferred in some cases, since it can be more convenient to use in a time-based feedback loop. The disclosed systems and methods are described with buffer size and buffer occupancy, which is the amount of data in the buffer, specified in units of time, unless otherwise noted. However, an embodiment may use buffer size and buffer occupancy specified in units of bytes.

The video streaming client module 700 can operate to avoid overflow of the stream buffer. When the stream buffer is full, the video client will stop fetching new data. When the stream buffer is no longer full, the video client will resume fetching new data. The video streaming client module 700 may use separate thresholds for stopping and resuming fetching new data. When the video client stops fetching new data to avoid buffer overflow, the network will not be fully utilized.

The video streaming client module 700 can also operate to avoid underflow of the stream buffer. Underflow of the stream buffer indicates that the incoming data does not keep up with the decoding and playback process. Video freezes will result from buffer underflows. Video freezes lower the quality of experience for a viewer of the video. Thus, buffer underflow is also not desired.

The video streaming client module 700 uses a quality adaptation control algorithm to decide from which representation the next segment should be fetched. An objective of the quality control adaptation algorithm is to avoid overflow or underflow of the elementary stream buffer module 709.

An example quality control adaptation algorithm includes evaluating network conditions, for example, by calculating TCP throughput from the transfer of the last segment. The algorithm may then pick the representation with the highest average bit rate that is below the measured TCP throughput. The TCP throughput estimated from the transfer of the last segment may be calculated using the equation Dᵢ=Lᵢ/Tᵢ, in which Lᵢ is the length of the i'th segment, Tᵢ is the time spent on finishing the complete transaction to transfer the segment, and Dᵢ is the TCP throughput estimated.

FIG. 15 is a graph of video bit rate versus presentation time for one representation of an example video. The graph shows the average bit rate of each segment in one representation. As illustrated in FIG. 15, video bit rate is often highly variable.

FIG. 16 is a graph of video buffer occupancy versus presentation time for the representation of the example video. Buffer occupancy is another way of showing the bit rate variation. A virtual video buffer model may be used to determine buffer occupancy. The buffer model is essential a leaky bucket that is filled by the network at certain constant rate and drained by the video decoder according to the decoding time stamp of video samples. Negative buffer occupancy values indicate that the video data is consumed by the decoder faster than it is being downloaded. The video buffer occupancy illustrated in FIG. 16 shows the buffer occupancy variation of one HTTP video streaming session, for a video client that fetches the segments from one representation and for video data that is transported at a rate equal to the average bit rate of that representation. Because the average bit rates of the segments at the beginning of this video representation exceed the average bit rate of the complete representation, the video buffer will constantly underflow. This shows a deficiency of making a representation decision based on the average segment length.

A video client, additionally or alternatively, can use buffer occupancy (BO) in deciding from which representation the next segment will be fetched. For example, the video client can incorporate the BO in the quality control adaptation algorithm by adjusting the estimation of TCP throughput using Dᵢ′=(Lᵢ/Tᵢ)*(BOᵢ/maxBO)*S, where Dᵢ′ is the adjusted TCP throughput, BOᵢ is the buffer occupancy after fetching i'th segment, maxBO is a maximum buffer occupancy (which may be less than the size of the physical buffer), and S is a scaling factor.

The video client can then use the adjusted estimation of TCP throughput Dᵢ′ to select the representation whose bit rate is just below Dᵢ′ in requesting the next segment. This quality control adaptation algorithm may be referred to as “HTTP streaming client quality adaptation with BO feedback.”

HTTP streaming client quality adaptation with BO feedback includes buffer occupancy in selecting between video representations. If the buffer occupancy is low, a representation with average bit rate lower than the actual TCP throughput will be selected in order to build up buffer occupancy. Since the client will stop fetching data if BO reaches the upper limit, maxBO, the scaling factor S, which is larger than 1.0, is introduced to set the operating point below maxBO.

FIG. 17 is another graph of video buffer occupancy versus presentation time for an example video. The graph of FIG. 17 illustrates operation of a HTTP streaming client quality adaptation with BO feedback. The graph is for a quality control adaptation algorithm with maxBO set to 50 seconds and scaling factor S set to 1.5.

FIG. 18 is a graph of selected representations versus presentation time corresponding to the video buffer occupancy variation of FIG. 17. For the example video, the representation indices range from 8 to 19, inclusive. As shown in the graph, the video client frequently switches between representations.

A video client using a quality control adaptation algorithm based on simple BO feedback may have some performance limitations. First, the client may switch among representations too frequently. This switching will have adverse effect on video quality. Second, the buffer may still reach its upper limit occasionally. The second limitation may be alleviated by increasing the scaling factor, but a higher scaling factor may push the average BO too low and make the video client more susceptible to buffer underflow. In addition, the switching among representations may become more frequent because the change in BO will have larger effect on the estimated TCP throughput.

FIG. 8 is a block diagram illustrating aspects of a video streaming client module with buffer occupancy prediction in accordance with aspects of the invention. The video streaming client module 800 may be implemented by, for example, the processor module 320 of the terminal node of FIG. 3. The video streaming client module 800 of FIG. 8 provides a quality control adaptation algorithm that more directly uses predicted future buffer occupancy. This is in contrast to the simple buffer occupancy feedback quality-control adaptation algorithm that uses the current buffer occupancy and makes representation selections based on the past. In addition, using TCP throughput estimation based on the transfer time of the previous segment may be inaccurate. The video streaming client module 800 uses the length of future segments, in number of bytes, that may be coupled with an improved TCP throughput estimation to predict future video buffer occupancy, thereby providing a better quality control adaptation algorithm. The quality-control adaptation algorithm used by the video streaming client module 800 can be referred to as “HTTP streaming client quality adaptation with BO-prediction.”

The video streaming client module 800 includes a top-level control module 801, a manifest access module 803, a video segment processor module 805, a video segment access module 807, an elementary stream buffer module 809, a segment transfer time prediction module 811, and an HTTP client module 813. The video streaming client module 800 interfaces with a TCP socket layer 830 and a video decoding and playback module 820. The video streaming client module 800 is similar to the video streaming client module 700 of FIG. 7 with its functional elements operating as described in connection with FIG. 7 unless otherwise noted.

The manifest access module 803 can process explicit signaling of segment lengths. That is, the manifest access module 803 can provide segment lengths that were explicitly signaled in a manifest or playlist file. If the manifest file does not include segment lengths, the manifest access module 803 can estimate the length of segments based on, for example, average bit rate of the representation, segment duration, and information about the segments already received.

A manifest file may use various ways of signaling the segment URLs. For example, a segment URL may be listed explicitly in the manifest file, or the URL can be derived using a template. Since the segment length is specific to a segment, signaling of the segment length in the manifest file may depend on how the segment URL is signaled. Methods of signaling segment length in the manifest file will be described for DASH MPD files. However, it should be noted, similar methods may be used for other formats.

A video segment is usually stored as a separate file. In this case, the manifest file may include a URL, or information required to construct a URL, to the file storing a video segment on the server. The length of the segment may be added to the manifest file and uniquely associated with the URL of the segment.

Table 3 shows how the segment length is added as an attribute, named “length” (other names may be used), to the element SegmentURL in a DASH MPD file. Optionally, a scale factor, named “segmentLengthScale” (other names may be used), may be specified at a higher level, such as MPD, or Period, or Representation, etc. The scale factor may be used to reduce the overhead of signaling the segment length, since it may not be necessary to signal the segment length in the precision down to a single byte. The manifest access module 803 can calculate the actual segment length by multiplying the length field value by the scale factor. If the scale factor is not present, it can be inferred to be 1. For the example shown in Table 3, the element “MPD” has an attribute “segmentLengthScale” which specifies a scale factor of 100, along with other attributes which are omitted from the listing. Element “SegmentList” specifies a list of segments of a representation. Inside “SegmentList”, element “Initialization” specifies the URL of the initialization segment which has the metadata of a video file, and element “SegmentURL” specifies the URL of the segment containing video data. Both element “Initialization” and element “Segment URL” have an attribute “length”. The length of the initialization segment can be calculated as “6*100=600 bytes”, while the length of the first video segment can be calculated as “4257*100=425700 bytes”.

TABLE 3
Add Segment Length Field for an MPD File with Explicit Signaling of
Segment URL

```
<MPD ......
    segmentLengthScale=”100”>
    <......>
    <BaseURL>http://www.example.com</BaseURL>
    <Period start=“PT0S”>
        <AdaptationSet mimeType=“video/3gpp”>
            <....../>
            <Representation codecs=“s263, samr” bandwidth=“256000” id=“256”>
                <BaseURL>“rep1”</BaseURL>
                <SegmentList duration=“1000” timescale=“100”>
                    <Initialization sourceURL=“seg-init.3gp” length=“6”/>/>
                    <SegmentURL media=“seg-1.3gp” length=“4257”/>
                    <....../>
                </SegmentList>
            </Representation>
            <......>
        </AdaptationSet>
    </Period>
    <......>
</MPD>
```

Video segments of one representation may be stored in one file, and the manifest file includes the information on how to access the segment. Such information may be indicated as a range as shown in the example in Table 4. In this case, it is not necessary to signal the length information separately, as the length can be derived from the range information. If the range starts from Sᵢ and ends at Eᵢ, both inclusive, for the i′th segment, the length of the segment may be calculated as Eᵢ−Sᵢ+1. For the example in Table 4, the length of the initialization segment is 680 bytes, and the length of the first video segment is 42567 bytes.

TABLE 4
Reuse Range for an MPD File with Segment URL specified as a Range
into a Video File

```
<MPD ......>
    <......>
    <BaseURL>http://www.example.com</BaseURL>
    <Period start=“PT0S”>
        <AdaptationSet mimeType=“video/3gpp”>
            <....../>
            <Representation codecs=“s263, samr” bandwidth=“256000” id=“256”>
                <BaseURL>“rep1”</BaseURL>
                <SegmentList duration=“1000” timescale=“100”>
                    <Initialization sourceURL=“nonseg.3gp” range=“0-679”/>
                    <SegmentURL media=“nonseg.3gp” mediaRange=“680-43246”/>
                    <....../>
                </SegmentList>
            </Representation>
            <......>
        </AdaptationSet>
    </Period>
    <......>
</MPD>
```

Segment URLs are often constructed in a specific pattern. A template such as showed in Table 5 is defined in DASH MPD for the client to construct the URLs of all segments. This makes the manifest file very compact. For this scenario, a new attribute, named as “segmentLengthList” (other names may be used) in Table 5, may be associated with a representation. The list includes the length of each segment in the representation.

Optionally, a scale factor, named as “segmentLengthScale” in the listing for example, may be specified at higher level, such as MPD, or Period, or Representation, etc. The actual segment length is calculated by multiplying the length field value in MPD file by the scale factor. In the example in Table 5, the lengths of three segments in representation “1” are specified as 41724, 71416, and 64123 respectively, while the lengths of three segments in representation “2” are calculated from the scale factor 1000 and individual length values as 22000, 38000, and 30000 respectively.

TABLE 5
Add a List of Segment Lengths to an MPD File Signaling Segment URLs
using Template

```
<MPD ......>
    <......>
    <BaseURL>http://www.example.com</BaseURL>
    <Period start=“PT0S”>
        <SegmentTemplate
            duration=“10”
            initialization=“seg-init-$RepresentationId$.3gp”
            media=“http://example.com/$RepresentationId$/$Number$.3gp”/>
        <AdaptationSet mimeType=“video/3gpp” codecs=“mp4v.20.9, mp4a.E1”>
            <......>
            <Representation bandwidth=“256000” id=“1”
                segmentLengthList=“41734,71416,64123”/>
            <Representation bandwidth=“128000” id=“2”
                segmentLengthScale=“1000” segmentLengthList=“22,38,30”/>
        </AdaptationSet>
    </Period>
</MPD>
```

The segment transfer time prediction module 811 estimates TCP throughput and predicts the transfer time of segments based on their lengths. Operation of the segment transfer time prediction module 811 can be understood in view of some examples of TCP transfer time in throughput for various network connections.

A first example is for both HTTP server and DASH client in the same local area network (LAN). A dummy-net pipe, which has 20 milliseconds latency and 3 Mbps bandwidth limit on each direction of network connection, is inserted for modeling purposes between the server and client. The video segments have a duration of 2 seconds. FIG. 19 is a graph of transfer time versus segment length for the first example. FIG. 20 is a graph of TCP throughput versus segment length for the first example.

As seen in FIG. 19, the segment transfer time has almost a linear relationship with the segment length, except the curve intersects the vertical axis at about 287 milliseconds. This indicates that there is an approximately fixed amount of overhead in transfer time in each TCP transaction.

TCP throughput shown in FIG. 20 is calculated from segment length and transfer time using Dᵢ=Lᵢ/Tᵢ, as defined above. It can be seen that TCP throughput is highly dependent on segment length. Thus, a quality control adaptation algorithm using Dᵢ=Lᵢ/Tᵢ in its estimates of throughput without considering the impact of segment length has a deficiency.

A second example is for a server located in ITEC of Klagenfurt University, Austria, and a client located in San Diego, Calif. The video segment duration is 6 seconds. FIG. 21 is a graph of transfer time versus segment length for the second example. FIG. 22 is a graph of TCP throughput versus segment length for the second example.

The relationships between transfer time and segment length and TCP throughput and segment length for the second example communication system are similar to those for the first example communication system. The second example communication system, however, exhibits slower TCP performance due to the effect of TCP slow start and congestion avoidance in a higher latency communication system. The data in FIG. 22 also shows that TCP throughput substantially depends on the segment length. During TCP slow start, the sender initially sends a small amount of packets and waits for the acknowledgement from the receiver. For each packet acknowledged, the sender sends two more packets, so the congestion window size effectively doubles after each round-trip time (RTT), or it grows exponentially. Once the congestion window size reaches a threshold (commonly referred to as ssthresh in configuring the TCP stack), TCP sender enters congestion avoidance phase. In this phase, the congestion window is adjusted in a manner termed additive increase/multiplicative decrease. The congestion window is increased by a fixed amount after every RTT, so it grows linearly. This fixed amount is normally 1 MSS (maximum segment size, a parameter of TCP protocol specifying the maximum size of a TCP segment) for additive increase after slow start. When congestion is detected, the congestion window is scaled by a constant less than 1, normally ½.

FIG. 23 is a graph showing a trace of TCP packets transferred versus time starting from the beginning of the transaction for an example video segment. From this packet trace, it is found that the initial congestion window size is just 3 packets, and the slow start threshold, ssthresh, is around 25 packets. After about 4 RTTs, the TCP sender changes from slow start to additive increase phase. During slow start and initial additive increase phases, the congestion window size is being increased, so the channel is not fully utilized in these phases. This shows up in both FIG. 19 and FIG. 21 as something similar to a fixed overhead in transfer time, especially in transferring long segments.

FIG. 24 is a graph of elapsed transfer time versus sequence number for an example video segment. The “TCP sequence number” in a TCP segment starts from an initial TCP sequence number that is a random number chosen at the time the TCP connection is established. However, the sequence number in FIG. 24 and other parts of the document, unless explained differently, is a relative sequence number which is calculated by subtracting the initial TCP sequence number from TCP sequence number in the TCP segment header of the current packet. FIG. 25 is a graph of transfer time starting from the beginning of the transaction versus sequence number for a portion of the example video of FIG. 24. These graphs are for a video session through the Internet. The relative TCP sequence number indicates the amount of data that has been transferred for a file at the time of measurement.

As seen in FIG. 24, the relationship between transfer time and sequence number for transferring the complete file is quite far from a straight line passing through the origin. As seen in FIG. 25, relationship between transfer time and sequence number for the later portion of the transfer can be approximated as a straight line reasonably well. However, this line does not pass through origin either. Instead it intersects the Y-axis at 1.84 seconds. This time offset matches reasonably well with the fixed offset of 2.52 seconds in the example illustrated in FIG. 21.

A video segment may also be transferred through a TCP connection already established without going through the slow start phase. For example, HTTP may keep a persistent connection so that one connection may be reused for more than one request. In this case, the transfer characteristics of a video segment will be different, and should be treated differently from that of a video segment that is transferred using TCP connection just established.

FIG. 9 is a flowchart of a process for quality control adaptation algorithm for video streaming with buffer occupancy prediction in accordance with aspects of the invention. The process may be performed, for example, by the video streaming client of FIG. 8. The process begins with obtaining a segment length corresponding to each one of a set of multiple video segments, each video segment being associated with one of multiple video representations (step 901). Next, a segment transfer time is predicted for each obtained segment length (step 903). In step 905, one of the multiple video representations is selected for obtaining subsequent video segment(s), the selection being based at least in part on a buffer occupancy prediction corresponding to each predicted segment transfer time. Then, in step 907, at least one video segment of the selected video representation is requested from a video server.

FIG. 10 is a flowchart of a process for the obtainment of segment lengths for video streaming with buffer occupancy prediction in accordance with aspects of the invention. The process may be used, for example, to perform step 901 of the process for video streaming with buffer occupancy prediction of FIG. 9. In FIG. 10, the obtainment of segment lengths begins with step 1001 in which the process determines if the manifest file specifies segment length. If yes, the segment length for a segment associated with a video representation is obtained from the manifest file (step 1003). If not, the process determines in step 1005 if the manifest file includes segment length attributes. If yes, the segment length for a segment associated with a video representation is derived from segment length attributes in the manifest file (step 1007). If not, an average segment length for segments associated with a video representation is determined based at least in part on a bit rate and a segment duration corresponding to the multiple video representation (step 1009).

FIG. 11 is a block diagram of a segment transfer time prediction module in accordance with aspects of the invention. The segment transfer time prediction module 1100 of FIG. 11 may be used to implement the segment transfer time prediction module 811 of FIG. 8. The segment transfer time prediction module 1100 can also be used with other video streaming clients, including clients that use different quality control adaptation algorithms such as the more basic BO-feedback algorithm. The segment transfer time prediction module 1100 estimates TCP throughput based on statistics collected from transferring prior segments. The segment transfer time prediction module 1100 establishes a relationship between the segment transfer time and the segment length. This relationship is used in predicting the transfer time of future segment of any length.

The segment transfer time prediction module 1100 shown in FIG. 11 includes a network transfer statistics collection module 1105, a network transfer function extraction module 1103, and a segment transfer time calculation module 1101. The network transfer statistics collection module 1105 may use various methods of segment transfer statistics collection depending, for example, on the availability of information from the HTTP client module.

In an embodiment, the network transfer statistics collection module 1105 collects statistics at the segment level. For the i'th segment, the network transfer statistics collection module 1105 collects a sample point that includes the transfer time (Tᵢ) of the complete segment and the length (Lᵢ) of the segment. In order to extract the transfer function robustly, the network transfer statistics collection module 1105 collects numerous sample points. However, since the segment duration in playback time is typically between 2 to 10 seconds, it may be difficult to collect a sufficient and relevant sample size if the channel varies quickly.

In an embodiment, the network transfer statistics collection module 1105 collects packet transfer timing information within the transfer of a segment. In this embodiment, many sample points (T′ᵢ, L′ᵢ) are collected during the transfer of a single segment. For each sample, the cumulative segment data received (in bytes), L′ᵢ, and the time elapsed from when the transfer starts (in seconds), T′ᵢ, are collected. This results in sample points equivalent to the relationship between TCP sequence number and the transfer time illustrated in FIG. 23. In a static channel, collection of packet transfer timing information within the transfer of one segment, if the segment is sufficiently large in size, is generally equivalent to collection of statistics at the segment level. However, in a dynamic channel, collection of packet transfer timing information within the transfer of a segment provides greatly improved data relevancy since the time period needed for data collection is much shorter. Collection of packet transfer timing information within the transfer of a segment can be used when the HTTP client has the capability of accessing the transfer timing information at the packet level from the socket layer and providing that information to the network transfer statistics collection module 1105.

Additional functionality in the network transfer statistics collection module 1105 can include the aggregation of statistics and management of a statistics window. The aggregation of statistics function accumulates the segment-level statistics and the packet-level statistics from multiple segments.

The network transfer statistics collection module 1105 can keep a statistics window to retire the statistics which are too old to be useful. Any sample point, whose age is older than an age limit (e.g., 10 seconds) may be removed from the statistics window and excluded from the aggregated statistics. The age limit may be determined based on current channel condition or on other factors. For example, for a rapidly varying channel, the age limit may be set to a smaller number than that for a slowly varying channel.

The statistics window may be managed by the following method. Each sample point, i, has a timestamp T′_{b,j} describing its collection time relative to the start of transfer of segment j. Please note that indices i and j in T′_{i,j} are not independent of each other. Index j just indicates that the timestamp T′_{b,j} is collected from transfer of segment of index j. If each segment j has a transfer start time of TOⱼ, then the age of each sample i can be computed as Age(i)=Current Time−TOⱼ−T′_{i,j}.

In a video client that may use persistent connection for fetching video segments, additional functionality in the network transfer statistics collection module 1105 can separate the aggregation of statistics type A for the segments transferred using new connections and aggregation of statistics type B for the segments transferred by reusing the connections already established. In one embodiment, these two types of statistics are aggregated and maintained separately. In another embodiment, the statistics type B is adjusted by adding a slow start phase, which is estimated from the statistics type A, and merged into the statistics type A.

A video client may transfer video segments from multiple servers. In addition, a video client may also have multiple network interfaces, and both may be used in requesting video segments. In both cases, the video client may transfer video segments through connections of very different transfer characteristics. In an embodiment, additional functionality in the network transfer statistics collection module 1105 can include aggregation of statistics for video segments transferred based on the combination of the server IP address and client IP address between which the connection is established. For example, a video client may be connected to internet through home broadband using wi-fi interface with IP address IP_C_W and through LTE network with IP_C_L. The video content is served from two servers with IP addresses IP_S_{—}0 and IP_S_{—}1. The network transfer statistics collection module 1105 may aggregate four types of statistics, one for each of the IP address combination, namely (IP_S_{—}0, IP_C_W), (IP_S_{—}0, IP_C_L), (IP_S_{—}1, IP_C_W), and (IP_S_{—}1, IP_C_L). Additional aggregation among different statistics types may be performed if certain network transfer statistics types exhibit similar characteristics.

The network transfer function extraction module 1103 establishes a relationship between the transfer time and segment length. That is, the network transfer function extraction module 1103 determines a function ƒ that maps segment length L to segment transfer time T.

The network transfer function extraction module 1103 can use an algorithm based on the statistics collected and maintained by the network transfer statistics collection module 1105. If the relationship is approximated as a linear combination of other functions, the relationship function may be established using linear regression. The relationship may also be approximated using other methods, such as a simple straight line, a piece-wise linear curve, curve-fitting, etc.

In one implementation, the relationship between the segment transfer time and segment length is approximated using a polynomial function. An example procedure for finding the best function using linear regression that may be performed by the network transfer function extraction module 1103 will be explained. The explanation assumes that the relationship may be approximated using a polynomial function of order K (K=1 fits to a straight line with an offset) so that the relationship function is T=Σₖ₊₀^{K}aₖL^{k}.

The linear regression procedure is to find a set of coefficients aₖ, k=0, . . . , K, to minimize the difference between the measured value and the predicted value by using the metric of sum of the squared difference E=Σᵢ₌₀^{M-1}(tᵢ−Tᵢ)², in which M is the number of sample points, Tᵢ is the i'th sample, and tᵢ is the predict value of the i′th sample. The predicted value is calculated as tᵢ=Σₖ₌₀^{K}aₖLᵢ^{k}.

The network transfer function extraction module 1103 may find the coefficients aₖ, k=0, . . . , K, by solving a set of linear equations Σₖ₌₀^{K}aₖXₚₖ=Yₚ, in which p assumes the value from 0 to K. Xₚₖ is calculated as Xₚₖ=Σᵢ₌₀^{M-1}Lᵢ^{k+p}, and Yₚ is calculated as Yₚ=Σᵢ₌₀^{M-1}Tᵢ·Lᵢ^{p}.

Regularization may be used in order to avoid over-fitting, especially when the amount of statistics is limited. At the initial phase, when the number of sample points is not sufficient to establish a robust relationship, a simple averaging can be used by the network transfer function extraction module 1103.

In an embodiment, network transfer statistics collection module 1105 aggregates and manages more than one type of network transfer statistics, the network transfer function extraction module 1103 may extract one network transfer function for each type of network transfer statistics.

The segment transfer time calculation module 1101 can predict the transfer time for a future segment of any length. The segment transfer time calculation module 1101 uses the relationship between segment transfer time and segment length from the network transfer function extraction module 1103. For example, for K=1, network transfer function extraction module 1103 may have calculated a₀ and a₁ to be 1.84 and 3.44×10⁻⁶, respectively. Thus, the segment transfer time calculation module 1101 can use the function T=3.44×10⁻⁶. L+1.84 to predict the transfer time T for a segment length L. In this example, a segment of length of 1 Mbyte results in a predicted transfer time of 5.28 seconds.

In an embodiment, network transfer function extraction module 1103 has more than one network transfer function each extracted from one type of network transfer statistics, collection module 1105 aggregate and manage more than one type of network transfer statistics, the segment transfer time calculation module 1101 may select the matching network transfer function to predict the transfer time for a future segment.

FIG. 12 is a flowchart of a process for segment transfer time prediction in accordance with aspects of the invention. The process may be implemented by, for example, the segment transfer time prediction module of FIG. 11. In FIG. 12, the process begins with step 1201 by collecting network transfer statistics for at least one previous transferred video segment. The network transfer statistics may also be collected from the process of transferring the manifest file, if the manifest file also resides on the same server as the segments whose transfer time is to be predicted. The usage of the network transfer statistics collected from the manifest file transfer may help the video streaming client in selecting the representations from which the first several segments should be fetched. Then in step 1203, a network transfer function is extracted based on the collected network transfer statistics. A segment transfer time is determined in step 1205 for each obtained segment length, each segment length corresponding to one of the video segments, and each video segment is associated with one of the multiple video representations.

FIG. 13 is a block diagram of a segment access representation selection module 1300 in accordance with aspects of the invention. The segment access representation selection module 1300 may, for example, be a component of the video segment access module 807 of the video streaming client module 800 of FIG. 8. The segment access representation selection module 1300 selects which representation the next segment should be fetched from. The segment access representation selection module 1300 selects a set of candidate representations, determines a representation selection cost for the candidate representations, and can then select a next segment to be fetched from the candidate representation that has the lowest representation selection cost.

The segment access representation selection module 1300 includes a representation candidate selection module 1301 that selects representations as candidates for the representation from which the next segment will be fetched. The representation candidate selection module 1301 may select a subset of the available representations. The representation candidate selection module 1301 may alternatively select all available representations as candidate representations. The representation candidate selection module 1301 supplies, for each representation candidate, the length of each segment inside an evaluation window that is immediately after the current segment in playback time. The segment lengths are sent, for example, to the segment transfer time prediction module, 811 which estimates the time to transfer the segments. The representation candidate selection module 1301 can receive information about the segments, for example, from the manifest access module 803.

The representation candidate selection module 1301 may select representations that are close in quality to the current representation. The representation candidate selection module 1301 may also select representations that are close in bit rate to the current representation. Other selection criteria may also be used. The current representation is the representation that the segment just fetched belongs to. For ease of description, it is assumed that the representations are ordered according to a selection criterion (e.g., a quality measure). For example, a representation of higher index has a better quality than the representation of lower index. The representation candidate selection module 1301 may then select representations with indices close to the index of the current representation. For example, if the current segment is from representation index 6, then candidate representations may be selected as representations of indices 4, 5, 6, 7, and 8. The quantity of candidates may be a constant or may vary depending on network or client conditions. For example, if the network conditions are changing rapidly, then a larger set of candidates may be evaluated as compared to the case where network conditions are changing more slowly.

The segment access representation selection module 1300 includes a buffer occupancy prediction module 1307. The buffer occupancy prediction module 1307 predicts buffer occupancy variations for the candidate representations. The buffer occupancy prediction module 1307 predicts the buffer occupancy variations using information about the current buffer occupancy and the estimated transfer times. The buffer occupancy prediction module 1307 may receive the current buffer occupancy, for example, from the elementary stream buffer 809.

The segment access representation selection module 1300 includes a representation selection cost function module 1303 that evaluates a cost function for each of the candidate representations. The cost function may also be referred to as an objective function. The cost function results may be determined using the predicted buffer occupancy variations from the buffer occupancy prediction module 1307. The segment access representation selection module 1300 may determine the cost function results for selecting a representation assuming that future segments will be fetched from the same representation.

The segment access representation selection module 1300 includes a representation selection module 1305 that selects the representation from which the next segment will be fetched. The segment access representation selection module 1300 generally selects the candidate representation that has the lowest cost function result. The index of the selected candidate representation and the index of a video segment to be fetched uniquely identify one video segment in the selected candidate video representation. A URL to the video segment may be formed with additional information in the manifest file as described above. The URL is supplied to HTTP client module 813 and causes the video segment in the selected candidate video representation to be fetched.

The segment access representation selection module 1300 may perform a complete representation selection process before each segment is fetched. Alternatively, the frequency with which the representation selection process is performed may depend on the channel condition and current BO level. For example, for a slow varying channel, the representation selection process can be performed less frequently. In another example, if the current BO level is far from either zero or the upper limit, the representation selection process may also be performed less frequently.

The buffer occupancy prediction module 1307 can predict that the buffer occupancy will be changed if the transfer time of a segment is different from its duration in playback time. For example, if a segment's duration is 2 seconds in playback time, and it takes 2.5 seconds to download, the buffer occupancy will be reduced by 0.5 seconds after the segment is downloaded and played. The buffer occupancy prediction module 1307 defines a “change of BO” for each segment for each candidate representation as the segment duration minus the predicted segment transfer time.

For each representation candidate, the BO is predicted for an evaluation window that includes a certain number of segments starting immediately after, in playback time, the segment that was just fetched. For example, if the segment just fetched was segment n, the evaluation window is over segments n+1 through n+m, where m is the evaluation window size in segments. The size of the evaluation window in playback time can be configured as a constant. For example, it can be configured to 40 seconds. If the duration of a segment is 2 seconds, the evaluation window may consist of 20 segments. At the end of the presentation, the evaluation window may consist of only the remaining segments. Alternatively, the size of evaluation window time may be variable, for example, depending on the channel condition.

For each candidate representation, the buffer occupancy prediction module 1307 adds the change of BO for every segment in the evaluation window to the current BO to predict the BO for each of the segments within the evaluation window. This set of BO predictions for a representation, computed for each segment in the evaluation window is also referred to as the BO variation for the representation. The use of an evaluation window can avoid switching across representations unnecessarily frequently.

The representation selection cost function module 1303 can use various cost functions. A cost function may be selected for use based, for example, on the metrics to be optimized by the quality adaptation control algorithm. The cost function may be selected dynamically. The cost function can, for example, be a function of: a current representation index, currentRepIdx; a representation candidate index, candidateRepIdx; a target client buffer occupancy, targetBO; a maximum predicted BO within evaluation window, maxPredBO(candidateRepIdx); a minimum predicted BO within evaluation window, minPredBO(candidateRepIdx); and an average predicted BO within evaluation window, avePredBO(candidateRepIdx).

A first example cost function that may be used by the representation selection cost function module 1303 is listed in Table 6. The first two terms in the cost function, C0*(minPredBO(candidateRepIdx)−targetBO)*(minPredBO(candidateRepIdx)−targetBO) and C1*(maxPredBO(candidateRepIdx)−targetBO)*(maxPredBO(candidateRepIdx)−targetBO), serve to guide the buffer occupancy to the target client buffer occupancy, targetBO. The last term in the cost function, C2*abs(currentRepIdx−candidateRepIdx), serves to provide additional control on how frequently the client switches among different representations. The constants, C0/C1/C2, can be selected to adjust the relative importance of each factor.

TABLE 6
Example Representation Selection Cost Function 1

```
C0 * (minPredBO(candidateRepIdx) − targetBO) *
    (minPredBO(candidateRepIdx) − targetBO) +
C1 * (maxPredBO(candidateRepIdx) − targetBO) *
    (maxPredBO(candidateRepIdx) − targetBO) +
C2 * abs(currentRepIdx − candidateRepIdx)
```

A second example cost function that may be used the representation selection cost function module 1303 is listed in Table 7. The second example cost function also includes three terms. The first term in the cost function uses the difference between the average predicted buffer occupancy and the target buffer occupancy. The second term in the cost function uses the difference between the maximum predicted buffer occupancy and the minimum predicted buffer occupancy. The third term in the cost function serves to limit how frequently the client switches among different representations. The constants, D0/D1/D2, can be selected to adjust the relative importance of each factor.

TABLE 7
Example Representation Selection Cost Function 2

```
D0 * (avePredBO(candidateRepIdx) − targetBO) *
    (avePredBO(candidateRepIdx) − targetBO) +
D1 * (maxPredBO(candidateRepIdx) − minPredBO(candidateRepIdx)) *
    (maxPredBO(candidateRepIdx) − minPredBO(candidateRepIdx)) +
D2 * abs(currentRepIdx − candidateRepIdx)
```

FIG. 14 is a flowchart of a process for segment access representation selection in accordance with aspects of the invention. The process may be performed, for example, by the segment access representation selection module 1300 of FIG. 13. The segment access representation selection process of FIG. 14 begins with step 1401 in which the predicted segment transfer time is obtained for each of the obtained segment lengths, each segment length corresponding to one of the video segments that may be fetched, each video segment being associated with one of the multiple candidate video representations and across an evaluation window. In step 1403, a buffer occupancy variation is predicted for each segment transfer time corresponding to each video segment length. A cost function result associated with each candidate video representation and based on predicted buffer occupancy variation for each segment transfer time is determined, each segment transfer time corresponding to an obtained segment length that corresponds with one of the video segments (step 1405). In step 1407, one of the multiple candidate video representations is selected based at least in part on a comparison among the cost function results corresponding to the segment lengths, each segment length corresponding to one of the video segments, and each video segment being associated with one of the multiple candidate video representations.

The streaming video client module illustrated in FIG. 8 is unlikely to reach the buffer limits. The video streaming client module also operates with reduced representation switching events. Since both reaching the buffer limits and representation switching events reduce the quality of experience for a user viewing a video, the video streaming client module can provide an improved user experience.

The foregoing described aspects and features are susceptible to many variations. Additionally, for clarity and concision, many descriptions of the aspects and features have been simplified. For example, the figures generally illustrate one of each type of module (e.g., one elementary stream buffer, one representation selection cost function module), but a video streaming client module may have multiple instances of some modules. Similarly, many descriptions use terminology and structures of a specific video standard. However, the disclosed aspects and features are more broadly applicable, including for example, other types of video transfer protocols, other types of network transport protocols, and other types of communication systems.

One variation of the video streaming client module uses a quality control adaptation algorithm without explicit signaling of segment length. If the segment lengths are not explicitly signaled in the manifest file, such as MPD file in DASH, the video streaming client module may assume that all of the future segments are of the same length. The average length of a segment in a representation may be calculated based on the average bit rate of the representation, such as bandwidth of a representation specified in DASH MPD file, and the duration of the segment. For example, if the average bit rate of the n'th representation is Rₙ bps (bits per second) and the duration of a segment is dₙ seconds, then the average length of a segment in this representation may be calculated as Lₙ=(Rₙ×dₙ)/8 bytes. This average segment length of a representation can then be used in predicting the future buffer occupancy. Alternatively, this average segment length can be refined in the streaming process based on the characteristics of the bitstream that has been received until the playback time of the last segment just transferred.

Another variation of the video streaming client module uses a quality control adaptation algorithm other than that described for HTTP streaming client quality adaptation with BO-prediction but with improved TCP throughput estimation. For example, the segment transfer time prediction module 1100 of FIG. 11 may be used in more accurately estimating the TCP throughput for use in quality control adaptation algorithms such as the more basic algorithm of quality control adaptation with BO-feedback. In this variation, the TCP throughput is not just estimated based on the transfer time and length of the previous segment. Instead, the TCP throughput is estimated based on the transfer function extracted based on network transfer characteristics.

More specifically, the following network transfer function is established using, for example, the network transfer function extraction module 1103 of FIG. 11 to estimate the transfer time T of an object, such as a video segment, to be transferred based on the size of the object L.

For each representation, the average length of a segment is calculated. The average length may be calculated as described above using Lₙ=(Rₙ×dₙ)/8, in which “n” is the index of a representation. The transfer time of a segment of the average length is estimated as Tₙ=ƒ(Lₙ).

The average TCP throughput is estimated as Lₙ/Tₙ. This estimated throughput can be used to replace the TCP throughput estimated simply from the transfer time and length of the last segment in constructing the other metrics used in selecting the representation from which the next segment should be fetched.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described a transmitting data to (or receiving from) a second device when there are intermediary devices that couple the first and second device and also when the first device is unaware of the ultimate destination of the data.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent particular aspects and embodiments of the invention and are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein.

What is claimed is:

1. A terminal node, comprising:
a transceiver module configured to communicate with an access node; and
a processor coupled to the transceiver module and configured to:
obtain a plurality of segment lengths each of which corresponds to each one of a set of video segments, each video segment being associated with one of multiple candidate video representations;
predict a segment transfer time for each obtained segment length; and
select one of the multiple candidate video representations, the selection being based at least in part on a buffer occupancy variation corresponding to each predicted segment transfer time.

2. The terminal node of claim 1, wherein the processor is further configured to request at least one video segment of the selected candidate video representation from a video streaming server.

3. The terminal node of claim 1, wherein each of the plurality of segment lengths is obtained from a manifest file.

4. The terminal node of claim 1, wherein each of the plurality of segment lengths is derived from segment length attribute data.

5. The terminal node of claim 1, wherein each of the plurality of segment lengths is calculated based at least in part on a bit rate and a segment duration corresponding to one of the multiple candidate video representations.

6. The terminal node of claim 1, wherein the processor is further configured to predict the segment transfer time by:
collecting network transfer statistics for at least one previous transferred packet;
extracting a network transfer function based on the collected network transfer statistics; and
determining a segment transfer time for each obtained segment length using the network transfer function, each segment length corresponding to one of the video segments.

7. The terminal node of claim 6, wherein the at least one previous transferred packet is a packet of a manifest file.

8. The terminal node of claim 6, wherein the at least one previous transferred packet is a packet of a video segment.

9. The terminal node of claim 1, wherein the processor is further configured to select one of the multiple candidate video representations by:
obtaining the segment transfer time for each obtained segment length, each segment length corresponding to one of the video segments of a candidate video representation;
predicting a corresponding buffer occupancy variation for each video segment based at least in part on the segment transfer time associated with the video segment;
determining a cost function result associated with each of the multiple candidate video representations, the cost function result being based at least in part on the predicted buffer occupancy variation for the video segment of the candidate video representation; and
selecting one of the multiple candidate video representations based at least in part on the cost function result associated with each of the multiple candidate video representations.

10. The terminal node of claim 1, wherein the multiple candidate video representations are selected from a set of video representations based at least in part on a current video representation index.

11. The terminal node of claim 9, wherein the cost function result is determined by a cost function based on at least one of a current video representation index, a candidate video representation index, a target client buffer occupancy, a maximum predicted buffer occupancy, a minimum predicted buffer occupancy and an average predicted buffer occupancy.

12. The terminal node of claim 11, wherein the cost function is evaluated over an evaluation window.

13. A video streaming client device for receiving video streaming data of a video presentation that is available in a plurality of candidate video representations, each of the candidate video representations including a plurality of video segments, the video streaming client device comprising:
a memory configured to store data and processing instructions; and
a processor configured to retrieve and execute the processing instructions stored in the memory to cause the processor to perform the steps of:
obtaining a plurality of segment lengths each of which corresponds to one of the plurality of video segments from each one of the candidate video representations;
predicting a segment transfer time for each obtained segment length; and
selecting one of the candidate video representations, the selection being based at least in part on a buffer occupancy variation corresponding to each predicted segment transfer time.

14. The video streaming client device of claim 13, wherein the processor is further configured to request at least one video segment of the selected candidate video representation from a video streaming server.

15. The video streaming client device of claim 13, wherein the segment length is obtained from a manifest file.

16. The video streaming client device of claim 13, wherein each of the plurality of segment lengths is derived from segment length attribute data.

17. The video streaming client device of claim 13, wherein each of the plurality of segment lengths is calculated based at least in part on a bit rate and a segment duration corresponding to one of the multiple candidate video representations.

18. The video streaming client device of claim 13, wherein the processor is further configured to predict the segment transfer time by:
collecting network transfer statistics for at least one previous transferred packet;
extracting a network transfer function based on the collected network transfer statistics; and
determining a segment transfer time for each of the obtained plurality of segment lengths using the network transfer function.

19. The video streaming client device of claim 18, wherein the at least one previous transferred packet is a packet of a manifest file.

20. The video streaming client device of claim 18, wherein the at least one previous transferred packet is a packet of a video segment.

21. The video streaming client device of claim 13, wherein the processor is further configured to select one of the multiple candidate video representations by:
obtaining the segment transfer time for each of the obtained plurality of segment lengths, each segment length corresponding to one of the video segments of a candidate video representation;
predicting a buffer occupancy variation for each corresponding video segment based at least in part on the segment transfer time associated with the video segment;
determining a cost function result associated with each of the multiple candidate video representations, the cost function result being based at least in part on the predicted buffer occupancy variation for the corresponding video segment of the candidate video representation; and
selecting one of the multiple candidate video representations based at least in part on the cost function result associated with each of the multiple candidate video representations.

22. The video streaming client device of claim 13, wherein the multiple candidate video representations are selected from a set of video representations based at least in part on a current video representation index.

23. The video streaming client device of claim 21, wherein the cost function result is determined by a cost function based on at least one of a current video representation index, a candidate video representation index, a target client buffer occupancy, a maximum predicted buffer occupancy, a minimum predicted buffer occupancy and an average predicted buffer occupancy.

24. The video streaming client device of claim 21, wherein the cost function is evaluated over an evaluation window.

25. A method for receiving video streaming presentation that has multiple candidate video representations, the method comprising:
obtaining a plurality of segment lengths each of which corresponds to each one of a set of video segments, each video segment being associated with one of the multiple candidate video representations;
predicting a segment transfer time for each obtained segment length; and
selecting one of the multiple candidate video representations, the selection being based at least in part on a buffer occupancy variation corresponding to each predicted segment transfer time.

26. The method of claim 25, further including the step of requesting at least one video segment of the selected candidate video representation from a video streaming server.

27. The method of claim 25, wherein each of the plurality of segment lengths is obtained from a manifest file.

28. The method of claim 25, wherein each of the plurality of segment lengths is derived from segment length attribute data.

29. The method of claim 25, wherein each of the plurality of segment lengths is calculated based at least in part on a bit rate and a segment duration corresponding to one of the multiple candidate video representations.

30. The method of claim 25, wherein the step of predicting the segment transfer time includes the steps of:
collecting network transfer statistics for at least one previous transferred video packet;
extracting a network transfer function based on the collected network transfer statistics; and
determining a segment transfer time for each of the obtained plurality of segment lengths using the network transfer function, each segment length corresponding to one of the video segments.

31. The method of claim 30, wherein the at least one previous transferred packet is a packet of a manifest file.

32. The method of claim 30, wherein the at least one previous transferred packet is a packet of a video segment.

33. The method of claim 25, wherein the step of selecting one of the multiple candidate video representations includes the steps of:
obtaining the segment transfer time for each of the obtained plurality of segment lengths, each segment length corresponding to one of the video segments of a candidate video representation;
predicting a corresponding buffer occupancy variation for each video segment based at least in part on the segment transfer time associated with the video segment;
determining a cost function result associated with each of the multiple candidate video representations, the cost function result being based at least in part on the predicted buffer occupancy variation for the video segment of the candidate video representation; and
selecting one of the multiple candidate video representations based at least in part on the cost function result associated with each of the multiple candidate video representations.

34. The method of claim 25, further including the step of selecting the multiple candidate video representations from a set of video representations based at least in part on a current video representation index.

35. The method of claim 33, wherein the cost function result is determined by a cost function based on at least one of a current video representation index, a candidate video representation index, a target client buffer occupancy, a maximum predicted buffer occupancy, a minimum predicted buffer occupancy and an average predicted buffer occupancy.

36. The method of claim 33, wherein the cost function is evaluated over an evaluation window.

37. A method for receiving video streaming of a video presentation that is available in a plurality of video representations, each of the video representations including a plurality of video segments, corresponding ones of the plurality of video segments in the plurality of video representations being aligned in presentation time, the method comprising:
determining, for each of a plurality of candidate video representations, a set of video segments in an evaluation window;
obtaining a segment size of each video segment in the set of video segments in the evaluation window;
predicting, using the obtained segment sizes, a segment transfer time for each video segment in the set of video segments in the evaluation window;
predicting a buffer occupancy for each video segment in the set of video segments, the predicted buffer occupancies being based on at least in part on the associated predicted segment transfer times; and
selecting, based at least in part on the predicted buffer occupancies, one of the plurality of candidate video representations.

38. The method of claim 37, further including requesting a video segment in the selected video representation from a video server.

39. The method of claim 37, wherein the segment sizes are obtained from a manifest file.

40. The method of claim 37, wherein the segment sizes are calculated based at least in part on bit rates and segment durations associated with the corresponding ones of the plurality of video segments.

41. The method of claim 37, further comprising:
collecting network transfer statistics for at least one transferred video packet; and
extracting a network transfer function based on the collected network transfer statistics,
wherein the predicted segment transfer times are predicted using the network transfer function.

42. The method of claim 41, wherein the video streaming of the video presentation is received via a persistent network connection and wherein the network transfer statistics for the at least one transferred video packet are associated with the persistent network connection.

43. The method of claim 41, wherein the video streaming of the video presentation is received from multiple video servers and wherein the network transfer statistics for the at least one transferred video packet are associated with at least one of the multiple video servers.

44. The method of claim 41, wherein the video streaming of the video presentation is received via multiple network interfaces and wherein the network transfer statistics for the at least one transferred video packet are associated with at least one of the multiple network interfaces.

45. The method of claim 37, further comprising selecting the plurality of candidate video representations from the plurality of video representations, the selected plurality of candidate video representations being video representations with bit rates close to a bit rate of a current video representation.

46. The method of claim 37, wherein selecting one of the plurality of candidate video representations comprises determining a cost function result associated with each of the plurality of candidate video representations, the cost function results being based at least in part on the predicted buffer occupancies for the corresponding one of the plurality of candidate representations, wherein the selected video representation is the one of the plurality of candidate video representations having the lowest cost function result.

47. The method of claim 46, wherein the cost function results are determined using a cost function based on one or more of a current video representation index, a candidate video representation index, a target client buffer occupancy, a maximum predicted buffer occupancy, a minimum predicted buffer occupancy, and an average predicted buffer occupancy.

48. The method of claim 37, wherein, for each of the plurality of candidate video representations, the video segments in the set of video segments number one.
